(19) United States
(12) Patent Application Publication
(10) Pub. No.: US 2010/0161764 A1
(43) Pub. Date: Jun. 24, 2010

(54) Content Information Deliver System

(75) Inventors: Yoshiyuki Ono, Shiojiri-shi (JP); Kazuhiko Kawahara, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/637,602

(22) Filed: Dec. 14, 2009

(30) Foreign Application Priority Data
Dec. 18, 2008 (JP) 2008-322790

(51) Int. Cl. G06F 15/16

(52) U.S. Cl. 709/219

(57) ABSTRACT

A relay server computer connected to a broadcaster server computer and a content information acquisition request unit via a network includes: a content information database constructing unit that acquires content information from the broadcaster server computer to construct a content information database; a content information acquisition request receiving unit; a content information acquisition unit that searches through the content information database to acquire content information corresponding to the content information acquisition request; and a content information transmitting unit that transmits the acquired content information to a content information acquisition request unit.

### CROSS-REFERENCE TO RELATED APPLICATIONS

This application claims the benefit of priority under 35 USC 119 of Japanese application no. 2008-322790, filed on Dec. 18, 2008, which is incorporated herein by reference.

### BACKGROUND

1. Technical Field

The present invention relates to a content information delivery system, and more particularly, to a content information delivery system capable of delivering content information without using a digital TV compatible with digital television broadcasting.

2. Related Art

Broadcasters broadcasting digital television broadcasts provide a service that delivers content information related to programs being broadcast to viewers. FIG. 1 is a diagram of a system configuration for implementing such a delivery service.

As illustrated in FIG. 1, digital television broadcasts are received by a digital TV 10 that is compatible with digital television broadcasting, and a user is then able to watch digital television broadcasts on the digital TV 10.

Some models of the digital TV 10 can connect to a home network 20. The network 20 may be connected to a printer 30 such that moving pictures received by the digital TV 10 can be printed as still images. In some cases, content information accompanying the digital television broadcasts is received by the digital TV 10 and can be transmitted via the network 20 to the printer 30 for printing.

In the example of FIG. 1, the printer 30 is connected to the Internet 40 via the network 20, and the broadcaster delivering the digital television broadcasts controls a broadcaster server computer 50 that is connected to the Internet 40. The broadcaster server computer 50 stores content information that concerns programs delivered by digital television broadcasting. A user who wants to print the content information using the printer 30 operates the digital TV 10 to designate a uniform resource identifier (URI) accessing the printer 30 and issues a print command. The accessing URI is delivered, for example, with the digital television broadcasts, and is acquired by the digital TV 10 by receiving the digital television broadcasts.

The printer 30 having received the print command accesses the designated URI via the Internet 40 to acquire and print the content information stored in the broadcaster server computer 50. In this way, the user is able to print the content information regarding the programs broadcast through digital television broadcasting using the printer 30. For example, if a cooking program is being broadcast through digital television broadcasting, the user is able to print content information provided by the broadcaster, such as information on a cooking recipe, using the printer 30 (see JP-A-2004-159245).

However, in order to print the content information by such a method, a digital TV 10 compatible with digital television broadcasting is indispensable. However, many televisions are not compatible with digital television broadcasting. It would be convenient if users watching programs on such televisions were able to perform printing using the printer 30. In addition, it would be more convenient if users who are not watching a television were able to perform printing using the printer 30.

A proposal has been made in which content information is reserved for printing by a printer (see JP-A-2007-235639). However, when printing the content information reserved for printing, a receiver compatible with digital television broadcasting such as a digital TV or a television tuner is indispensable. Therefore, a technique that enables printing of content information reserved for printing without intervention of a television or a tuner compatible with digital television broadcasting is desirable.

### SUMMARY

The invention advantageously provides a technique that enables users to acquire and print content information without using a digital TV or tuner compatible with digital television broadcasting.

According to an aspect of the invention, a relay server computer that is connected to a broadcaster server computer of a broadcaster and a content information acquisition request unit of a user via a network includes: a content information database constructing unit that acquires content information from the broadcaster server computer to construct a content information database; a content information acquisition request receiving unit that receives a content information acquisition request from the content information acquisition request unit; a content information acquisition unit that searches through the content information database to acquire content information corresponding to the content information acquisition request when the content information acquisition request receiving unit has received the content information acquisition request; and a content information transmitting unit that transmits the content information acquired by the content information acquisition unit to the content information acquisition request unit.

In this case, the content information acquisition request may include a designation of a broadcaster that is requested to transmit the content information; and, the content information acquisition unit may search through the content information database to acquire content information of the broadcaster included in the content information acquisition request.

In this case, the relay server computer may further include a reception date identification unit that identifies the date at which the content information acquisition request receiving unit receives the content information acquisition request, and the content information acquisition unit may acquire the content information that corresponds to the broadcaster included in the content information acquisition request and the date identified by the reception date identification unit from the content information database.

The relay server computer may further include a reception date identification unit that identifies the date at which the content information acquisition request receiving unit receives the content information acquisition request; a content information view list transmitting unit that identifies content information of all broadcasters corresponding to the date identified by the reception date identification unit and generates and transmits a content information view list thereof to the content information acquisition request unit; and a transmission content designation receiving unit that receives a transmission content designation that is information for identifying content information designated based on the content information view list, wherein the content information acquisition unit may search through the content information database to acquire content information corresponding to the transmission content designation when the transmission content designation receiving unit has received the transmission content designation.

In this case, the content information database may store therein additional information data accompanying the content information so as to correspond to the content information; and, the content information view list transmitting unit may search through the content information database to acquire the additional information data with respect to the content information of all broadcasters corresponding to the date identified by the reception date identification unit, and transmit the additional information data to the content information acquisition request unit with the additional information data included in the content information view list.

Moreover, the content information database constructed by the content information database constructing unit may store therein the content information, the broadcasters, and the broadcast time of the broadcasters in a correlated manner.

According to another aspect of the invention, a printer that is connected via a network to a relay server computer having a content information database constructed by content information acquired from a broadcaster server computer includes: a print request receiving unit that receives a content information print request from a user; a content information print request transmitting unit that transmits a content information print request to the relay server computer when the print request receiving unit has received the content information print request; a print data receiving unit that receives print data in response to the content information print request from the relay server computer; and a print execution unit that executes printing based on the print data received by the print data receiving unit.

According to a further aspect of the invention, a content information delivery system is provided having a relay server computer that delivers content information acquired from a broadcaster server computer of a broadcaster to a content information acquisition request unit of a user via a network. The relay server computer includes a content information database constructing unit that acquires content information from the broadcaster server computer to construct a content information database. The content information acquisition request unit includes: a content information acquisition request receiving unit that receives a content information acquisition request from a user; and a content information acquisition request transmitting unit that transmits a content information acquisition request to the relay server computer when the content information acquisition request receiving unit has received the content information acquisition request. The relay server computer further includes: a content information acquisition request receiving unit that receives the content information acquisition request from the content information acquisition request unit; a content information acquisition unit that searches through the content information database to acquire content information corresponding to the content information acquisition request when the content information acquisition request receiving unit has received the content information acquisition request; and a content information transmitting unit that transmits the content information acquired by the content information acquisition unit to the content information acquisition request unit. The content information acquisition request unit further includes a content information receiving unit that receives the content information from the relay server computer.

In this case, the content information acquisition request unit may further include a print execution unit that executes printing based on the content information received by the content information receiving unit.

Alternatively, the content information acquisition request unit may further include a content information storage unit that stores the content information received by the content information receiving unit.

According to a still further aspect of the invention, a recorder that is connected via a network to a relay server computer having a content information database constructed by content information acquired from a broadcaster server computer includes: a content information acquisition request receiving unit that receives a content information acquisition request from a user; a content information acquisition request transmitting unit that transmits the content information acquisition request to the relay server computer when the content information acquisition request receiving unit has received the content information acquisition request; a content information receiving unit that receives content information in response to the content information acquisition request from the relay server computer; and a content information storage unit that stores the content information received by the content information receiving unit.

### BRIEF DESCRIPTION OF THE DRAWINGS

The invention will be described with reference to the accompanying drawings, wherein like numbers reference like elements.

FIG. 1 is a block diagram of a content information delivery system of the related art.

FIG. 2 is a block diagram of a content information delivery system according to embodiments of the invention.

FIG. 3 is a block diagram of a broadcaster server computer of the content information delivery system of FIG. 2.

FIG. 4 is a block diagram of a relay server computer of the content information delivery system of FIG. 2.

FIG. 5 is a block diagram of a printer of the content information delivery system of FIG. 2.

FIG. 6 is a flowchart of a content information delivery process in a content information delivery system according to a first embodiment of the invention.

FIG. 7 is a diagram of a content information correspondence table that is prepared in a content information database constructed by the relay server computer of FIG. 4.

FIG. 8 is a diagram of a content information print command window displayed on a display screen of the printer of FIG. 5.

FIG. 9 is an example view of the printed results of content information obtained by the printer of FIG. 5 executing the process of FIG. 6.

FIG. 10 is a flowchart of a content information delivery process in a content information delivery system according to a second embodiment of the invention.

FIG. 11 is a diagram of an additional information table that is prepared in a content information database constructed by the relay server computer of FIG. 4.

FIG. 12 is a diagram of a content information list window displayed on a display screen of the printer of FIG. 5.

FIG. 13 is an example view of the printed results of content information obtained by the printer of FIG. 5 executing the process of FIG. 10.

FIG. 14 is a diagram of a content information list window displayed on a display screen of the printer of FIG. 5 according to a modification of the second embodiment of the invention.

FIG. 15 is a block diagram of a content information delivery system according to a third embodiment of the invention.

FIG. 16 is a block diagram of a recorder of the content information delivery system of FIG. 15.

FIG. 17 is a flowchart of a content information delivery process in the content information delivery system according to the third embodiment of the invention.

FIG. 18 is a diagram of a reservation information input window displayed on a display screen of the recorder of FIG. 15.

FIG. 19 is a diagram of an acquired content information storage table that is prepared in a hard disk drive of FIG. 15.

FIG. 20 is a diagram of an acquired content information list window displayed on a display screen of the recorder of FIG. 15.

### DESCRIPTION OF EXEMPLARY EMBODIMENTS

Hereinafter, exemplary embodiments of the invention will be described with reference to the accompanying drawings. It is to be noted that the technical scope of the invention is not limited to the embodiments described below.

### First Embodiment

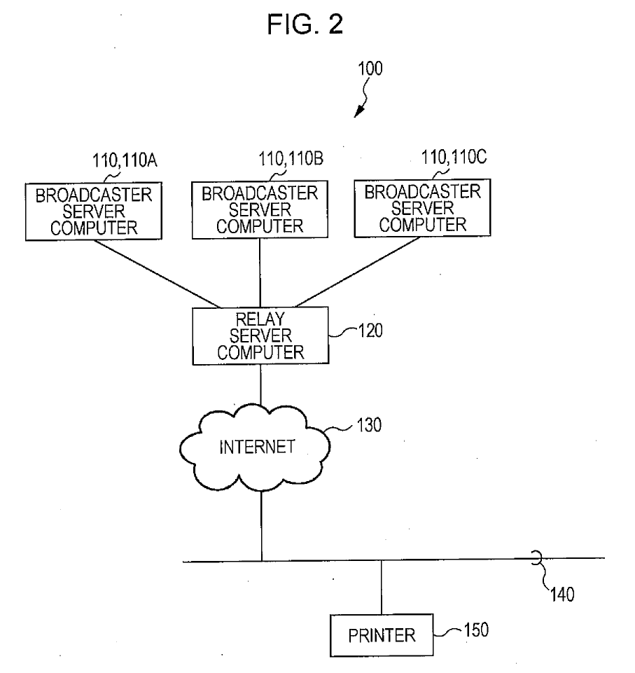

FIG. 2 is a block diagram of a content information delivery system 100 according to the present embodiment. As illustrated in FIG. 2, the content information delivery system 100 includes a relay server computer 120 that is connected to a plurality of broadcaster server computers 110 via a network. The relay server computer 120 acquires content information from each of the broadcaster server computers 110 to construct a content information database.

The number of broadcaster server computers 110 connected to the relay server computer 120 is arbitrary. That is, only one broadcaster server computer 110 may be connected to the relay server computer 120, or alternatively, plural, such as two or three, broadcaster server computers 110 may be connected to the relay server computer 120. In the example of FIG. 2, three broadcaster server computers, namely, a broadcaster server computer 110A of a broadcaster 1, a broadcaster server computer 110B of a broadcaster 2, and a broadcaster server computer 110C of a broadcaster 3, are connected to the relay server computer 120.

The relay server computer 120 is also connected to the Internet 130. The Internet 130 is an example of a public network that is accessible by general public users. In the example of FIG. 2, a printer 150 is connected to the Internet 130 via a home network 140. Therefore, the printer 150 is able to access the relay server computer 120 via the network 140 and the Internet 130. The printer 150 is an example of a content information acquisition request unit that transmits a content information transmission request to the relay server computer 120 to acquire content information from the relay server computer 120.

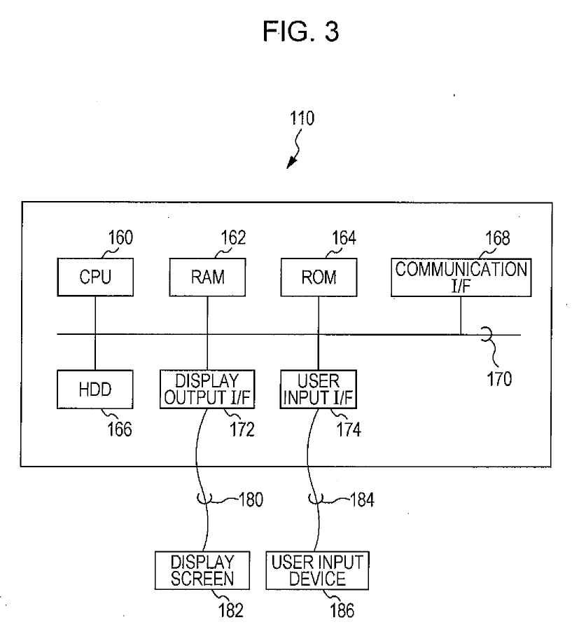

FIG. 3 is a block diagram of the broadcaster server computer 110. As illustrated in FIG. 3, the broadcaster server computer 110 includes a CPU (central processing unit) 160, a RAM (random access memory) 162, a ROM (read only memory) 164, a hard disk drive 166, and a communication interface 168 that are connected to each other via an internal bus 170.

The CPU 160 is a control unit that controls the overall operations of the broadcaster server computer 110. When realizing the various control operations, the CPU 160 reads necessary programs from the ROM 164 or the hard disk drive 166, or writes produced data into the RAM 162 or the hard disk drive 166.

The hard disk drive 166 is a so-called large-capacity auxiliary storage device that stores therein various control data as well as programs in a nonvolatile manner. Particularly, in the present embodiment, the hard disk drive 166 stores therein content information created by the broadcaster as a content information database.

The communication interface 168 realizes communication between the broadcaster server computer 110 and the relay server computer 120. The broadcaster server computer 110 and the relay server computer 120 may be connected via a private line or via a public line such as the Internet.

The internal bus 170 is connected to a display output interface 172 and a user input interface 174. The display output interface 172 is connected to a display screen 182 via a cable 180. The display screen 182 is configured by a CRT (cathode ray tube) display or a liquid crystal display, for example. In the example of FIG. 3, although the display screen 182 is provided separately from a main body of the broadcaster server computer 110, the display screen 182 may be provided integrally with the main body of the broadcaster server computer 110.

The user input interface 174 is connected to a user input device 186 via a cable 184. The user input device 186 is configured by a keyboard, a mouse, and various control buttons, for example. In the example of FIG. 3, although the user input device 186 is provided separately from the main body of the broadcaster server computer 110, the user input device 186 may be provided integrally with the main body of the broadcaster server computer 110.

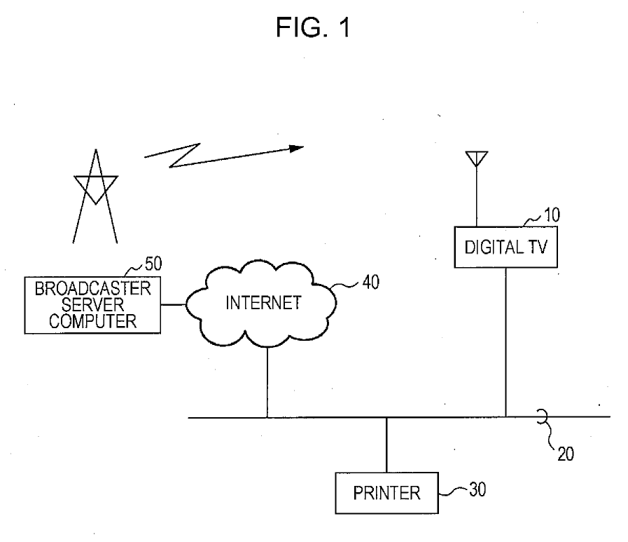

A user of the broadcaster server computer operates the user input device 186 to store content information regarding digital television broadcast programs in the hard disk drive 166 and construct a content information database in the hard disk drive 166 in advance. The content information of the content information database constructed in the hard disk drive 166 corresponds to the content information that the printer 30 acquires from the broadcaster server computer 50 via the Internet 40 in the related-art configuration of FIG. 1.

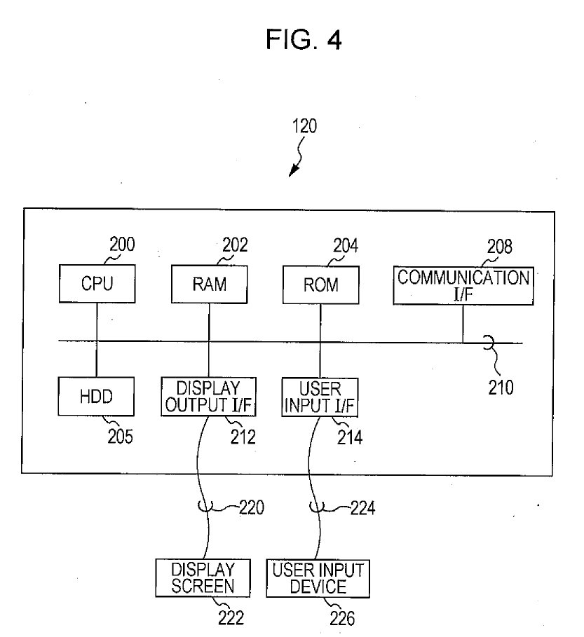

FIG. 4 is a block diagram of the relay server computer 120. As illustrated in FIG. 4, the relay server computer 120 includes a CPU (central processing unit) 200, a RAM (random access memory) 202, a ROM (read only memory) 204, a hard disk drive 206, and a communication interface 208 that are connected to each other via an internal bus 210.

The CPU 200 is a control unit that controls the overall operations of the relay server computer 120. When realizing the various control operations, the CPU 200 reads necessary programs from the ROM 204 or the hard disk drive 206, or writes produced data into the RAM 202 or the hard disk drive 206.

The hard disk drive 206 is a so-called large-capacity auxiliary storage device that stores therein various control data as well as programs in a nonvolatile manner. Particularly, in the present embodiment, the hard disk drive 206 stores therein content information acquired from the broadcaster as a content information database.

The communication interface 208 realizes communication between the relay server computer 120 and the broadcaster server computer 110. As described above, the relay server computer 120 and the broadcaster server computer 110 may be connected via a private line or via a public line such as the Internet.

Moreover, the communication interface 208 enables the relay server computer 120 to connect to the Internet 130. That is, the relay server computer 120 connects to the Internet 130 via the communication interface 208.

The internal bus 210 is connected to a display output interface 212 and a user input interface 214. The display output interface 212 is connected to a display screen 222 via a cable 220. The display screen 222 is configured by a CRT (cathode ray tube) display or a liquid crystal display, for example. In the example of FIG. 4, although the display screen 222 is provided separately from a main body of the relay server computer 120, the display screen 222 may be provided integrally with the main body of the relay server computer 120.

The user input interface 214 is connected to a user input device 226 via a cable 224. The user input device 226 is configured by a keyboard, a mouse, and various control buttons, for example. In the example of FIG. 4, although the user input device 226 is provided separately from the main body of the relay server computer 120, the user input device 226 may be provided integrally with the main body of the relay server computer 120.

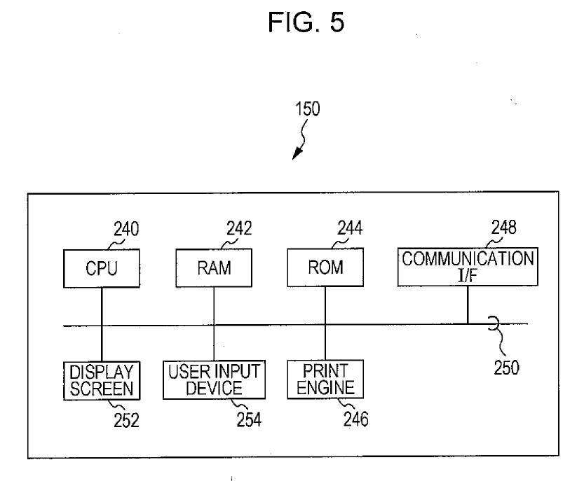

FIG. 5 is a block diagram of the printer 150. As illustrated in FIG. 5, the printer 150 includes a CPU (central processing unit) 240, a RAM (random access memory) 242, a ROM (read only memory) 244, a print engine 246, and a communication interface 248 that are connected to each other via an internal bus 250.

The CPU 240 is a control unit that controls the overall operations of the printer 150. For example, the CPU 240 performs various control operations that are necessary when the printer 150 executes printing. When realizing the various control operations, the CPU 240 reads necessary programs from the ROM 244 or writes produced data into the RAM 242.

The print engine 246 is a mechanism unit that performs printing on a print medium such as a printing sheet. The print engine 246 may be configured by an ink jet printing mechanism or a laser beam printing mechanism, for example. The CPU 240 produces data necessary for controlling the print engine 246 based on print data and causes the print engine 246 to perform printing.

The communication interface 248 connects the printer 150 to the network 140. The printer 150 is connected to the network 140 and the Internet 130 via the communication interface 248.

The internal bus 250 is connected to a display screen 252 and a user input device 254. In the present embodiment, the display screen 252 is configured by a small-size liquid crystal display, for example.

In the present embodiment, the user input device 254 is configured by a number pad and several control buttons, for example. When the display screen 252 is configured by a touch panel, the user input device 254 may be configured to be integral with the display screen 252.

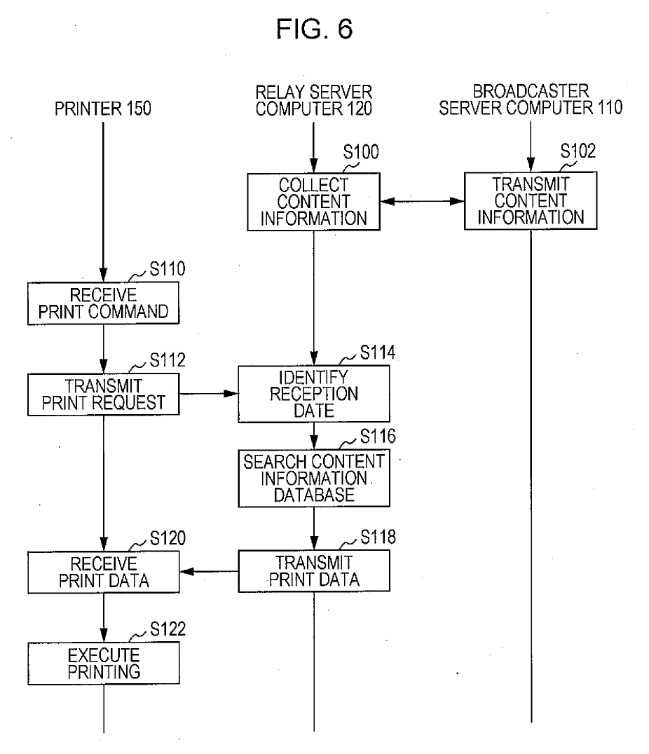

A content information delivery process in the content information delivery system 100 according to the present embodiment of the invention is described with reference to FIG. 6. FIG. 6 is a flowchart for describing the exchange of data or requests between the printer 150, the relay server computer 120, and the broadcaster server computer 110.

The processes that the broadcaster server computer 110 executes in FIG. 6 are realized when the CPU 160 of the broadcaster server computer 110 reads and executes predetermined programs stored in the ROM 164, for example. Moreover, the processes that the relay server computer 120 executes in FIG. 6 are realized when the CPU 200 of the relay server computer 120 reads and executes predetermined programs stored in the ROM 204, for example. Furthermore, the processes that the printer 150 executes in FIG. 6 are realized when the CPU 240 of the printer 150 reads and executes predetermined programs stored in the ROM 244, for example.

As illustrated in FIG. 6, the relay server computer 120 communicates with the broadcaster server computer 110 of a broadcaster to acquire content information from the broadcaster server computer 110 and construct a content information database (steps S100 and S102). Specifically, the relay server computer 120 constantly acquires content information from the broadcaster server computer 110 and constructs a content information database based on the acquired content information. The time at which the relay server computer 120 acquires the content information is arbitrary, and various timings can be considered.

For example, the broadcaster server computer 110 may transmit content information of programs to the relay server computer 120 as needed when a broadcaster delivers the programs by digital television broadcasting. Alternatively, the content information may be collected on a periodic basis, such as once per hour or once per day, and be transmitted from the broadcaster server computer 110 to the relay server computer 120. In this case, content information on programs that are not yet broadcast will be stored in the content information database held in the relay server computer 120.

Moreover, when the content information acquired from,the broadcaster server computer 110 is encoded in a data format such as XML that is not suitable for printing, the relay server computer 120 may convert the content information into a data format suitable for printing such as PDF or JPEG and construct the content information database.

The relay server computer 120 stores the content information for each broadcaster in a state that it is correlated with a broadcast time of a program. For example, the database is constructed so that specific content information can be acquired by searching through the content information database based on a broadcaster and time information.

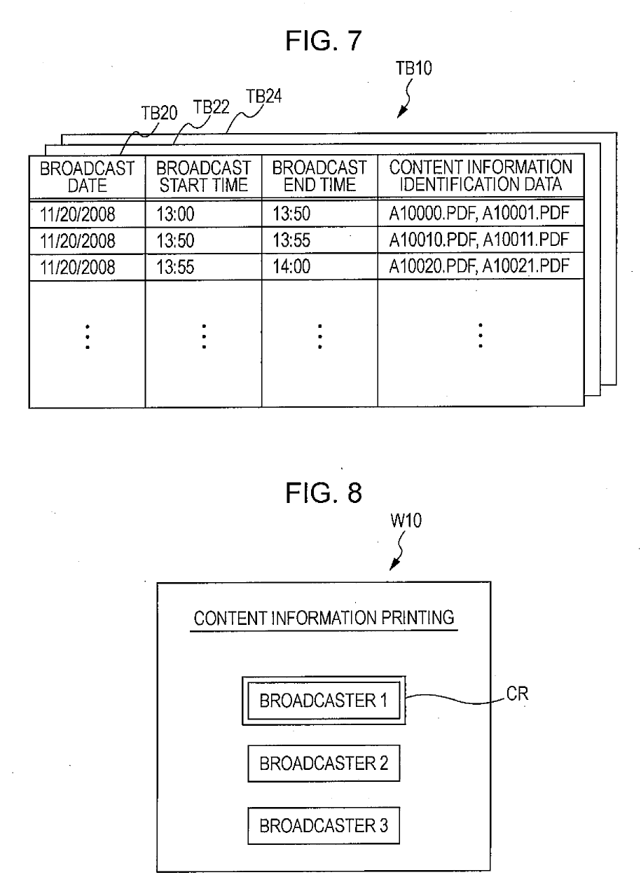

In the present embodiment, in order to realize such a search in the content information database, a content information correspondence table TB10 as illustrated in FIG. 7 is prepared in the content information database. The content information correspondence table TB10 includes an individual content information correspondence table TB20 of the broadcaster 1, an individual content information correspondence table TB22 of the broadcaster 2, and an individual content information correspondence table TB24 of the broadcaster 3. In the example of FIG. 7, although there are three broadcasters, an individual content information correspondence table is prepared for each broadcaster.

The detailed configuration of the individual content information correspondence table TB20 will be described as an example. The individual content information correspondence table TB20 includes “broadcast date,” “broadcast start time,” “broadcast end time” and “content information identification data” as its data items. The “content information identification data” stores therein information identifying data that is requested for content information transmission from the printer and are actually transmitted to the printer.

The “broadcast date” stores therein a broadcast date of a program corresponding to the content information; the “broadcast start time” stores therein the time at which the broadcast of the program corresponding to the content information starts; and the “broadcast end time” stores therein the time at which the broadcast of the program corresponding to the content information ends. However, when the present embodiment is implemented, the “broadcast date” refers to the date on which the content information is transmitted to the printer; the “broadcast start time” refers to the time at which the transmission of the content information to the printer starts; and the “broadcast end time” refers to the time at which the transmission of the content information to the printer ends.

For example, in the example of the individual content information correspondence table TB20 of FIG. 7, upon receiving a content information transmission request with the designated broadcaster 1 between Nov. 20, 2008 13:00 and Nov. 20, 2008 13:50, the relay server computer 120 will retrieve two files, A10000.PDF and A10001.PDF, from the content information database and transmit the files to the printer as print data.

As illustrated in FIG. 6, a user of the printer 150 inputs a content information print command to the printer 150 at an arbitrary time (step S110). For example, when the user wants to print content information of a program that the user is watching on a television, the user designates a broadcaster broadcasting the program and causes the printer 150 to acquire and print the content information.

FIG. 8 is a diagram of a content information print command window W10 displayed on the display screen 252 when the user instructs the printer 150 to print content information. The content information print command window W10 illustrated in FIG. 8 can be reached by the user inputting appropriate operations on a menu screen.

A screen page for selecting a broadcaster is displayed in the content information print command window W10. In the present embodiment, since it is assumed that there are three broadcasters 1, 2 and 3, a screen page for selecting any one of the three broadcasters is displayed.

In the example of FIG. 8, a cursor CR is also displayed on the content information print command window W10, and the user operates the user input device 254 to move the cursor CR onto a broadcaster providing the content information that the user wants to print and inputs a print command using the user input device 254. In the following description, it will be assumed that the user has input a command for printing the content information of the broadcaster 1. Although the user designates the broadcaster in the example of the content information print command window W10 of FIG. 8, when the broadcasters and channel numbers are correlated with one to one correspondence, the user may designate a channel number on the content information print command window W10 to identify the broadcaster.

As illustrated in FIG. 6, upon receiving the content information print command, the printer 150 transmits a content information print request to the relay server computer 120 (step S112). In the present embodiment, although the content information print request includes information identifying the broadcasters as information for identifying the content information to be printed, time information identifying programs is not included. This is because the time information can be identified automatically by the relay server computer 120 that receives the print request. However, the time at which the printer 150 receives the print request from the user may be included in the print request as time information for identifying the programs.

Upon receiving the content information print request, the relay server computer 120 identifies the date on which the print request is received (step S114). The date can be identified, for example, by using a clock function of the relay server computer 120.

Next, the relay server computer 120 searches through the content information database based on the broadcaster identification information included in the print request and the date information identified in step S114 to identify the content information to be transmitted to the printer 150 (step S116).

For example, assuming that the date, on which the print request is received, as identified in step S114, is Nov. 20, 2008 13:10, the relay server computer 120 searches through the individual content information correspondence table TB20 of the broadcaster 1 to identify two files, A10000.PDF and A10001.PDF, as the content information to be transmitted to the printer 150.

Next, the relay server computer 120 transmits the content information identified in step S116 to the printer 150 as print data (step S118). That is, the content information identified in step S116 is read from the content information database and transmitted to the printer 150.

In the above example, the relay server computer 120 reads data of the two files, A10000.PDF and A10001.PDF, from the content information database and transmits the data to the printer 150 as the print data.

Upon receiving the print data (step S120), the printer 150 drives the print engine 246 to execute printing (step S122). In the above example, since the printer 150 has received and acquired two files, A10000.PDF and A10001.PDF, as the content information, the acquired two files are used as the print data and printed.

In this way, the print process of content information is completed, which process is performed when the user instructs the printer 150 to print content information of a designated broadcaster.

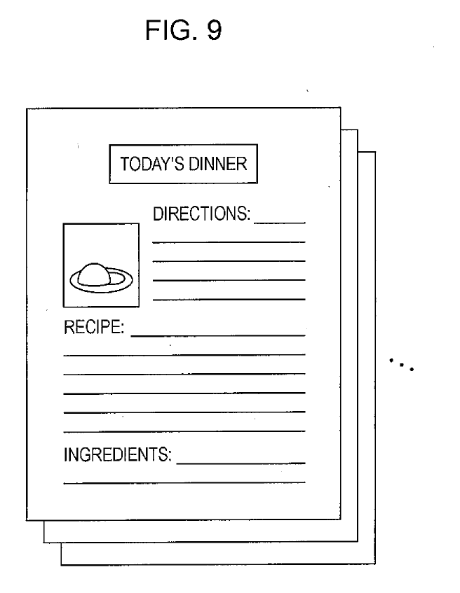

FIG. 9 is an example view of the printed results by execution of printing in step S122. For example, when the user was watching a cooking program and the user has requested printing of the content information of the broadcaster broadcasting the program, the printer 150 prints a recipe for cooking food, as illustrated in FIG. 9.

As described above, according to the content information delivery system 100 of the present embodiment, the user is able to obtain the printed results of content information only by designating a broadcaster broadcasting the content information that the user wants to print and instructing the printer 150 to print the content information. Therefore, it is possible to print content information of broadcasters using the printer 150 without using a digital TV compatible with digital television broadcasting, which was necessary in the related art.

When instructing the printer 150 to print the content information, the user can perform printing by inputting information identifying the broadcaster of the content information. This is because in step S114 of FIG. 6, the relay server computer 120 having received the content information print request is configured to identify the date of receipt thereof and retrieve the content information to be transmitted to the printer 150 based on the receipt date. Therefore, the user can print the content information using the printer 150 with simple operations.

In the present embodiment, step S110 may be modified such that the user instructs the printer 150 to print content information without designating a broadcaster. In this case, the relay server computer 120 having received the content information print request identifies the receipt date and searches through the individual content information correspondence tables TB20, TB22, and TB24 of all broadcasters based on the identified date. Then, all corresponding content information is identified and the content information of all broadcasters is transmitted to the printer 150. Thus, the printer 150 will acquire and print all content information of programs being broadcast at that time. With such a structure, the user does not have to identify the broadcaster and thus the user can print the content information using the printer 150 with simpler operations.

### Second Embodiment

The second embodiment modifies the first embodiment in such a manner that the user acquires a list of content information that can be printed by the printer 150 from the relay server computer 120, selects content information to be printed from the list, and causes the printer 150 to print the selected content information. The portions different from the first embodiment will be described below.

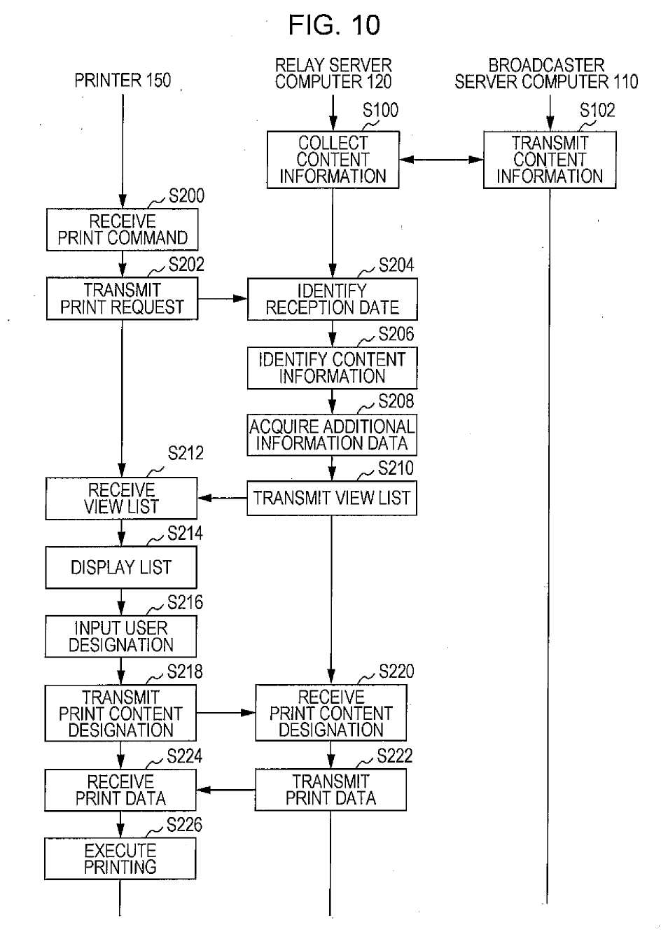

FIG. 10 is a flowchart of a content information delivery process in the content information delivery system 100 according to the present embodiment, which corresponds to FIG. 6 in the first embodiment. That is, FIG. 10 illustrates the exchange of data or requests between the printer 150, the relay server computer 120, and the broadcaster server computer 110.

The processes that the broadcaster server computer 110 executes in FIG. 10 are realized when the CPU 160 of the broadcaster server computer 110 reads and executes predetermined programs stored in the ROM 164, for example. Moreover, the processes that the relay server computer 120 executes in FIG. 10 are realized when the CPU 200 of the relay server computer 120 reads and executes predetermined programs stored in the ROM 204, for example. Furthermore, the processes that the printer 150 executes in FIG. 10 are realized when the CPU 240 of the printer 150 reads and executes predetermined programs stored in the ROM 244, for example.

As illustrated in FIG. 10, the relay server computer 120 communicates with the broadcaster server computer 110 of a broadcaster to acquire content information from the broadcaster server computer 110 and construct a content information database (steps S100 and S102). The processes in steps S100 and S102 are the same as those of the first embodiment, and the constructed content information database has the same structure as the first embodiment.

The user of the printer 150 inputs a content information print command to the printer 150 at an arbitrary time (step S200). For example, when the user wants to print content information of a program that the user is watching on a television, the user designates a broadcaster broadcasting the program and causes the printer 150 to acquire and print the content information. The specific method of designating the broadcaster is the same as the first embodiment. In the following description, it will be assumed that the user has input a content information print command with the broadcaster 1 designated, similar to the first embodiment.

Upon receiving the content information print command, the printer 150 transmits a content information print request to the relay server computer 120 (step S202). Although the content information print request includes information identifying the broadcasters as information for identifying the content information to be printed, time information identifying programs is not included similar to the first embodiment. This is because the time information can be identified automatically by the relay server computer 120 that receives the print request. However, the time at which the printer 150 receives the print request from the user may be included in the print request as time information for identifying the programs.

Upon receiving the content information print request, the relay server computer 120 identifies the date on which the print request is received (step S204). The date can be identified, for example, by using a clock function of the relay server computer 120.

Next, the relay server computer 120 searches through the content information database based on the broadcaster identification information included in the print request and the date information identified in step S204 to identify all the content information that can be printed (step S206).

For example, similar to the first embodiment, assuming that the date on which the print request is received, as identified in step S204, is Nov. 20, 2008 13:10, the relay server computer 120 searches through the individual content information correspondence table TB20 of the broadcaster 1 to identify two files, A10000.PDF and A10001.PDF, as the printable content information.

Next, the relay server computer 120 searches through the content information database based on the content information obtained in step S206 to acquire additional information data of the content information (step S208).

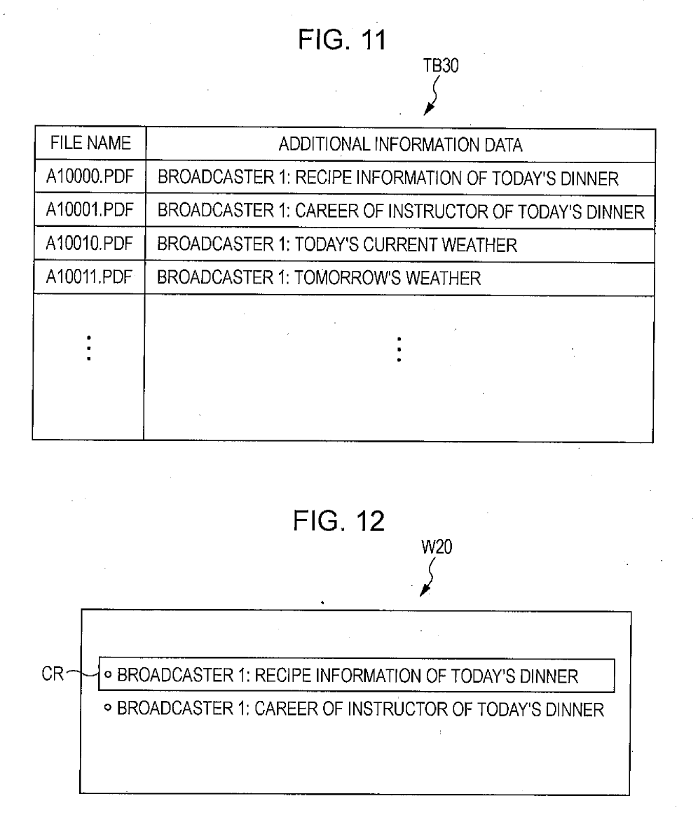

FIG. 11 is a diagram of an additional information table TB30 that is prepared in a content information database according to the present embodiment. As illustrated in FIG. 11, the additional information table TB30 stores therein a file name of a file serving as the content information and additional information data which is information accompanying the file. The additional information data is input when the broadcaster constructs the content information database in the broadcaster server computer 110. The relay server computer 120 acquires the additional information data from the content information database of the broadcaster server computer 110 and stores the additional information data in the additional information table TB30 to be correlated for each file name.

In the above example, the content information acquired in step S206 has file names A10000.PDF and A10001.PDF, the relay server computer 120 acquires “broadcaster 1: recipe information for today's dinner” as the additional information data of A10000.PDF and “broadcaster 1: career of instructor for today's dinner” as the additional information data of A10001.PDF from the additional information table TB30.

Next, the relay server computer 120 creates a view list of printable content information based on the file name, which is information identifying the printable content information as identified in step S206 and the additional information data acquired in step S208, and transmits the view list to the printer 150 (step S210).

Upon receiving the view list of the printable content information (step S212), the printer 150 displays the view list on the display screen 252 (step S214). FIG. 12 is a diagram of a content information list window W20 that is displayed on the display screen 252 in step S214.

As illustrated in FIG. 12, the view list of the printable content information received in step S212 is displayed on the content information list window W20 to be selectable by the user. In the present embodiment, although the additional information data accompanying the content information is displayed on the content information list window W20, the file name, which is the information identifying the content information, is not displayed. However, the file name may be displayed on the content information list window W20 together with the additional information data.

In the present embodiment, a cursor CR is also displayed on the content information list window W20, and the user operates the user input device 254 to move the cursor CR onto the content information that the user wants to print, thereby inputting a print command (Step S216). The user may be able to designate only one content information to be printed and alternatively may be able to designate a plurality of content information. In the following description, it will be assumed that the user has designated “broadcaster 1: career of instructor for today's dinner.”

Next, the printer 150 transmits a printing content designation, which is information identifying the content information designated by the user, to the relay server computer 120 (step S218). In the present embodiment, the printing content designation uses the file name that is included in the view list of content information. Then, the relay server computer 120 receives the printing content, designation (step S220).

Upon receiving the printing content designation, the relay server computer 120 transmits the files of content information designated by the printing content designation to the printer 150 as print data (step S222). That is, the files of the designated content information are read from the content information database and transmitted to the printer 150.

In the above example, since the user is designating “broadcaster 1: career of instructor for today's dinner,” the printing content designation includes a file name A10001.PDF. Therefore, the relay server computer 120 reads A10001.PDF from the content information database and transmits it to the printer 150 as the print data.

Upon receiving the print data (step S224), the printer 150 drives the print engine 246 to execute printing (step S226). In the above example, since the printer 150 has received one file A10001.PDF as the print data, the file is printed.

In this way, the print process of content information is completed, which process is performed when the user instructs the printer 150 to print content information with a designated broadcaster and individually designates the content information to be printed from the view list of printable content information.

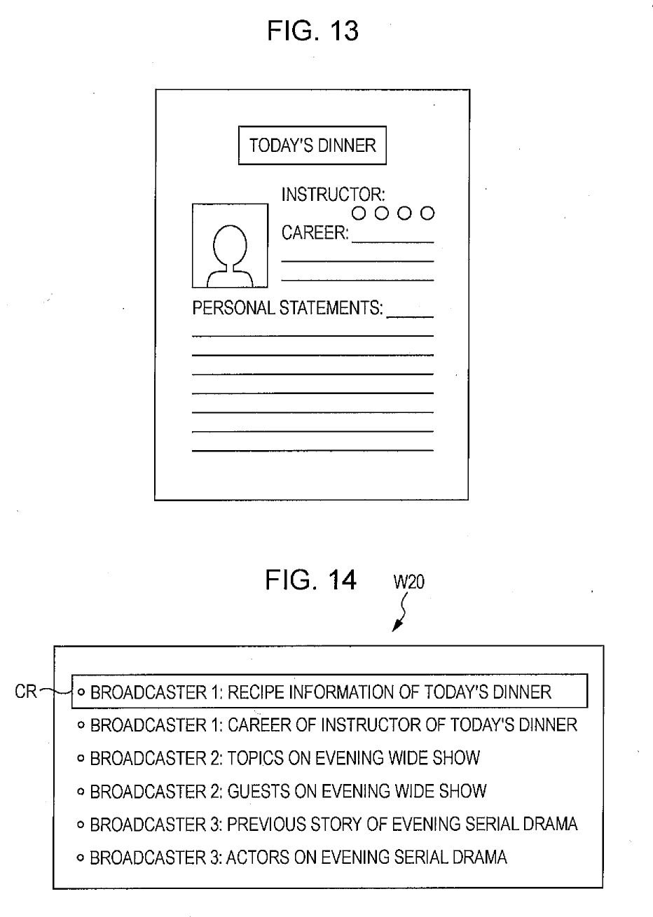

FIG. 13 is an example view illustrating the printed results by execution of printing in step S226. For example, similar to the first embodiment, when the user was watching a cooking program and the user has requested printing of the content information of the program, the printer 150 prints the content information regarding the cooking program, as illustrated in FIG. 13. However, differently from the first embodiment, A10000.PDF, which is the content information regarding the food recipe, is not printed, but A10001.PDF, which is the content information regarding the career of an instructor for today's dinner, is printed. By doing so, it is possible to prevent unnecessary content information from being printed.

As described above, according to the content information delivery system 100 of the present embodiment, the user is able to obtain the printed results of content information only by operating the printer 150. Therefore, it is possible to print content information of broadcasters using the printer 150 without using a digital TV compatible with digital television broadcasting, which was necessary in the related art.

When instructing the printer 150 to print the content information, the user inputs information identifying a broadcaster of the content information. Then, the content information list window W20, which is the list of printable content information, is displayed on the printer 150. Therefore, the user can selectively print the content information by designating only the content information that the user wants to print from the list. Therefore, it is possible to prevent occurrence of a situation where the printer 150 prints the content information that the user does not want to print, thus consuming printing paper wastefully.

In the present embodiment, step S200 may be modified such that the user instructs the printer 150 to print content information without designating a broadcaster. In this case, the relay server computer 120 having received the content information print request identifies the receipt date of the print request and searches through the individual content information correspondence tables TB20, TB22, and TB24 of all broadcasters based on the identified date. Then, a view list of all corresponding printable content information and the corresponding broadcaster providing the content information identified from the broadcasters 1-3 is created and transmitted to the printer 150 in step S210. Thus, in step S214, the view list of printable content information is displayed on the content information list window W20 regardless of the broadcasters.

FIG. 14 is a diagram of a view list of printable content information that is displayed on the content information list window W20 as the result of execution of step S214. As illustrated in FIG. 14, the printable content information is displayed for each of the broadcasters 1-3 as a view list. The user selects content information of a broadcaster that the user wants to print from the view list. With such a structure, the user does not have to identify the broadcaster at the time of inputting a content information print command to the printer 150, and thus the user can print the content information using the printer 150 with simpler operations.

### Third Embodiment

The third embodiment modifies the first embodiment in such a manner that the user makes a content information acquisition reservation on a recorder that automatically accesses the relay server computer 120 at the reserved time to acquire content information from the relay server computer 120 and stores the acquired content information in a hard disk drive. The portions different from the first embodiment will be described below.

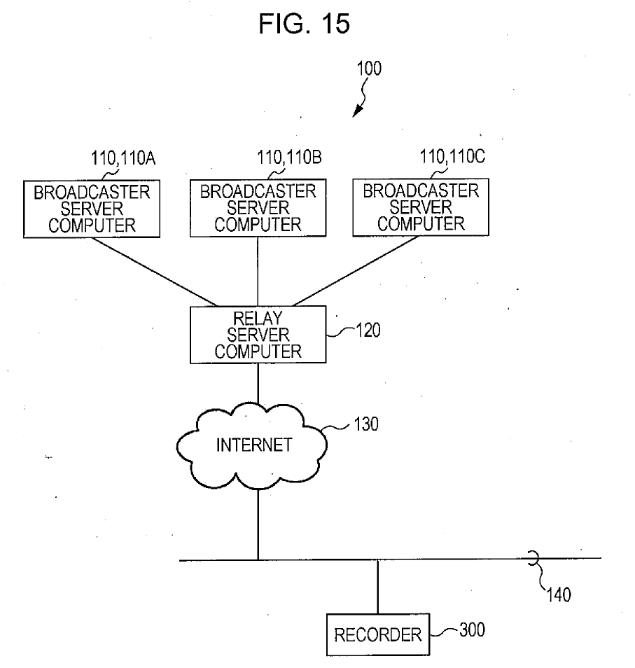

FIG. 15 is a block diagram of a content information delivery system 100 according to the present embodiment. As illustrated in FIG. 15, the content information delivery system 100 according to the present embodiment includes a recorder 300 in place of the printer 150. That is, the recorder 300 is connected to the home network 140, and the recorder 300 is connected to the Internet 130 and the relay server computer 120 via the network 140. The recorder 300 is an example of a content information acquisition request unit that transmits a content information transmission request to the relay server computer 120 to acquire content information from the relay server computer 120.

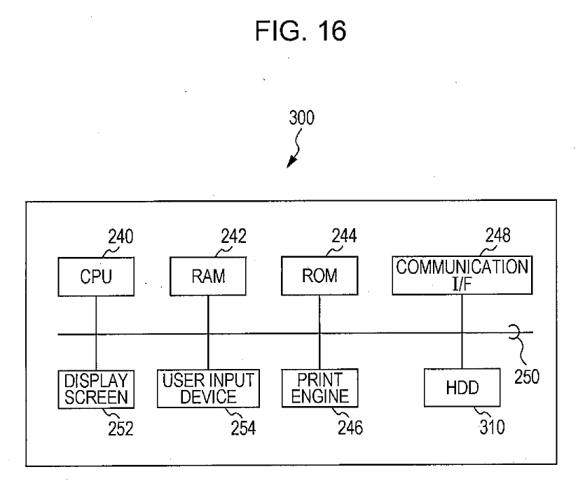

FIG. 16 is a block diagram of the recorder 300 according to the present embodiment. As illustrated in FIG. 16, the recorder 300 is configured by additionally incorporating a hard disk drive 310, which is an example of a large-capacity storage device, into the printer 150 of FIG. 5. Thus, it can be considered that the recorder 300 is configured by additionally incorporating a recorder function into the printer 150 of FIG. 5. The hard disk drive 310 has stored therein content information which is acquired based on the content information acquisition reservation.

In the present embodiment, the printing function is not necessarily essential. Therefore, the recorder 246 may be configured without the print engine 246. When the print engine 246 is not mounted on the recorder 300, the user may be able to view the content information stored in the hard disk drive 310 by displaying the content information on the display screen 252. Moreover, the user may be able to print the content information stored in the hard disk drive 310 using an external printer that is connected to the recorder 300.

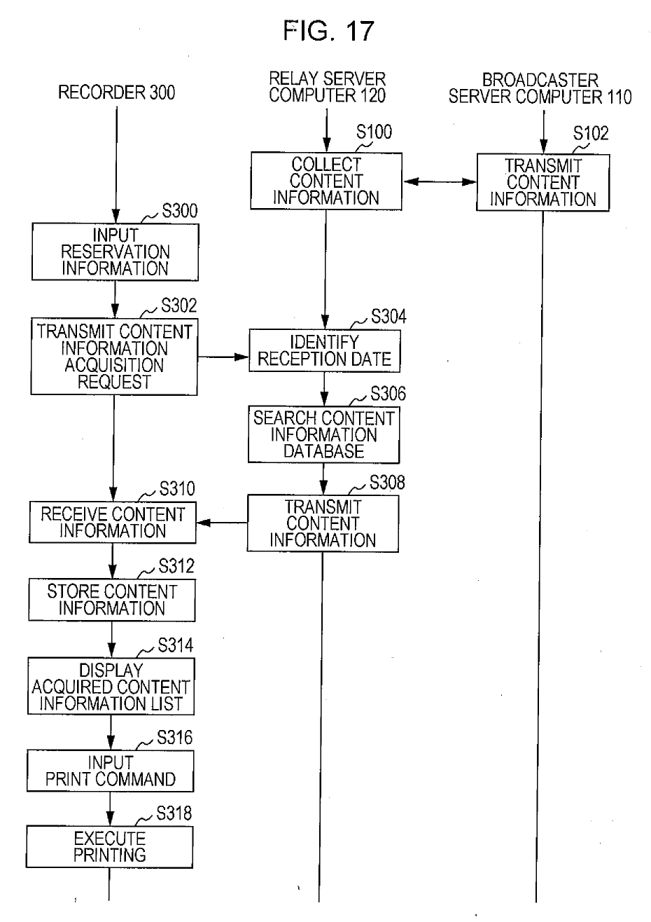

FIG. 17 is a flowchart of a content information delivery process in the content information delivery system 100 according to the present embodiment, which corresponds to FIG. 6 in the first embodiment. That is, FIG. 17 illustrates the exchange of data or requests between the recorder 300, the relay server computer 120, and the broadcaster server computer 110.

The processes that the broadcaster server computer 110 executes in FIG. 17 are realized when the CPU 160 of the broadcaster server computer 110 reads and executes predetermined programs stored in the ROM 164, for example. Moreover, the processes that the relay server computer 120 executes in FIG. 17 are realized when the CPU 200 of the relay server computer 120 reads and executes predetermined programs stored in the ROM 204, for example. Furthermore, the processes that the recorder 300 executes in FIG. 17 are realized when the CPU 240 of the recorder 300 reads and executes predetermined programs stored in the ROM 244, for example.

As illustrated in FIG. 17, the relay server computer 120 communicates with the broadcaster server computer 110 of a broadcaster to acquire content information from the broadcaster server computer 110 and construct a content information database (steps S100 and S102). The processes in steps S100 and S102 are the same as those of the first embodiment, and the constructed content information database has the same structure as the first embodiment.

The user of the recorder 300 inputs information regarding content information acquisition reservation to the recorder 300 at an arbitrary time (step S300). For example, when the user wants to acquire content information of a program that the user is watching on a television, the user designates a broadcaster broadcasting the program and the time at which the content information is to be acquired and makes a content information acquisition reservation on the recorder 300.

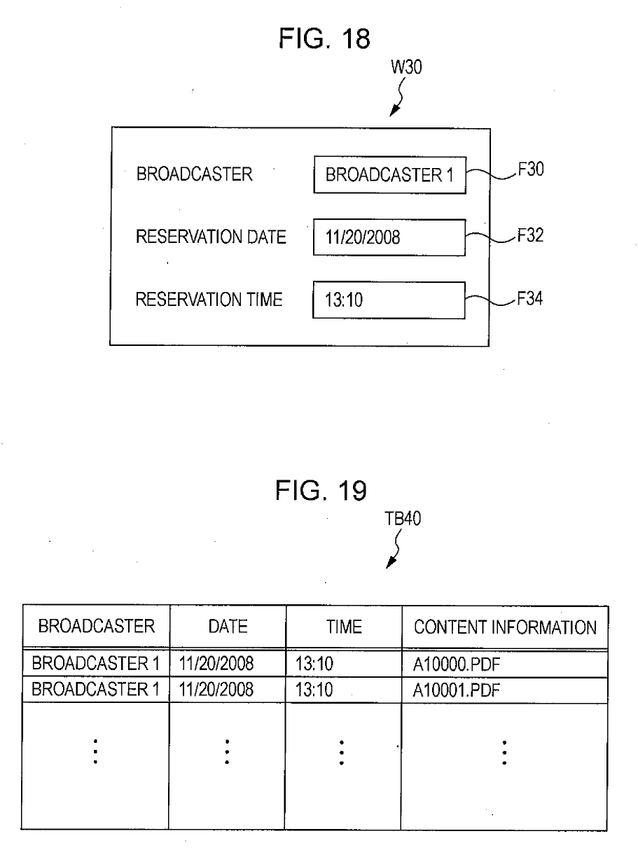

FIG. 18 is a diagram of a reservation information input window W30 that is displayed on the display screen 252 when a user makes a reservation for content information acquisition to the recorder 300. The reservation information input window W30 of FIG. 18 can be reached by the user inputting appropriate operations on a menu screen.

On the reservation information input window W30, the user operates the user input device 254 to input the following information: information identifying a broadcaster broadcasting the content information that the user wants to acquire into a field F30; the date on which the content information is to be acquired into a field F32; and the time at which the content information is to be acquired into a field F34. In this way, the user is able to make an acquisition reservation on the recorder 300 by inputting reservation information into the fields F30, F32, and F34 and completing the input operation by confirming the information being input. In the following description, it will be assumed that the user has designated the broadcaster 1 as a broadcaster, Nov. 20, 2008 as a reservation date, and 13:10 as a reservation time.

The recorder 300 has a clock function, and based on the clock function, the recorder 300 is able properly to compare the reserved acquisition time being input with the current time. When it comes to the reserved acquisition time being input, the recorder 300 transmits a content information acquisition request requesting transmission of content information to the relay server computer 120 (step S302). In the present embodiment, the content information acquisition request includes information identifying a broadcaster as the information for identifying the content information to be acquired. However, time information or the like is not included in the content information acquisition request. This is because the time information can be identified automatically by the relay server computer 120 that receives the content information acquisition request. However, the information on the reserved acquisition date being input or the like may be included in the content information acquisition request that the recorder 300 transmits as the information for identifying a program.

Upon receiving the content information acquisition request, the relay server computer 120 identifies the date on which the content information acquisition request is received (step S304). The date can be identified, for example, by using a clock function of the relay server computer 120.

Next, the relay server computer 120 searches through the content information database based on the broadcaster identification information included in the content information acquisition request and the date information identified in step S304 to identify the content information that is to be transmitted to the recorder 300 (step S306).

For example, similar to the first embodiment, assuming that the date on which the content information acquisition request is received, as identified in step S306, is Nov. 20, 2008 13:10, the relay server computer 120 searches through the individual content information correspondence table TB20 of the broadcaster 1 to identify two files, A10000.PDF and A10001.PDF, as the content information that is to be transmitted to the recorder 300.

Next, the relay server computer 120 transmits the content information identified in step S306 to the recorder 300 (step S308). That is, the content information identified in step S306 is read and acquired from the content information database and transmitted to the recorder 300.

In the above example, the relay server computer 120 reads and acquires data of the two files, A10000.PDF and A10001.PDF, from the content information database and then transmits the data to the recorder 300 as the content information.

Upon receiving the content information (step S310), the recorder 300 stores the content information in the hard disk drive 310 (step S312). FIG. 19 is a diagram of an acquired content information storage table TB40 that is prepared in the hard disk drive 310 in order to store the acquired content information in the hard disk drive 310.

As illustrated in FIG. 19, the recorder 300 stores the content information acquired in step S310 so as to be correlated with a corresponding broadcaster, the date on which the user made reservations, and the time at which the user made reservations. In this way, the acquisition of the content information by the recorder 300 is completed.

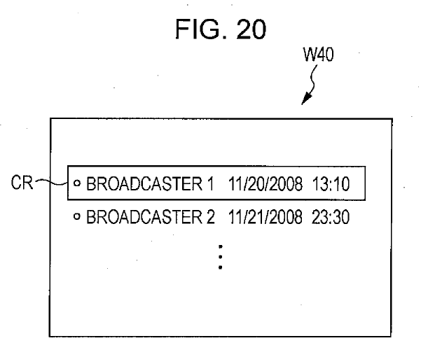

The user operates the recorder 300 at an arbitrary time to display an acquired content information list window W40 on the display screen 252 (step S314). FIG. 20 is a diagram of the acquired content information list window W40 that is displayed in step S314. The acquired content information list window W40 if FIG. 20 can be reached by the user inputting appropriate operations on a menu screen. As illustrated in FIG. 20, a list of content information stored in the acquired content information storage table T340 is displayed in the acquired content information list window W40 displayed on the display screen 252. That is, a list of content information that the recorder 300 has acquired from the relay server computer 120 and that is stored in the hard disk drive 310 is displayed in the acquired content information list window W40.

On the acquired content information list window W40, the user operates the user input device 254 to move the cursor CR onto the content information that the user wants to print, thus designating the content information. When the designation is completed, the user inputs a print command to the recorder 300 (step S316).

Upon receiving the print command, the recorder 300 executes printing of the content information designated by the user (step S318). In the above example, the print engine 246 is driven to print two files A10000.PDF and A10001.PDF. The printed results obtained by this operation are the same as those of FIG. 9 in the first embodiment. That is, the user is able to print and acquire the recipe for cooking food, as illustrated in FIG. 9, even when the content information print command is not issued within the time zone in which the program is being broadcast.

As described above, according to the content information delivery system 100 of the present embodiment, the user is able to acquire content information and print it later only by making an acquisition reservation on the recorder 300 while designating a broadcaster broadcasting the content information that the user wants to print and the date on which the content information is to be acquired. Therefore, it is possible to acquire content information of broadcasters using the recorder 300 without using a digital TV compatible with digital television broadcasting, which was necessary in the related art.

Moreover, the user is able to acquire and print the content information by making an acquisition reservation on the recorder 300 even when the user is unavailable at the time zone when the user wants to acquire the content information. Therefore, the user can acquire the content information with further improved convenience.

In the present embodiment, step S300 may be modified such that the user can make a content information acquisition reservation on the recorder 300 without designating a broadcaster. In this case, the recorder 300 transmits the content information acquisition request to the relay server computer 120 without identifying the broadcaster at the reserved time that the user has input. The relay server computer 120 having received the content information acquisition request from the recorder 300 searches through the individual content information correspondence tables TB20, TB22, and TB24 of all broadcasters based on the time information identified by the received reservation time to identify all corresponding content information and transmits the content information of all broadcasters to the recorder 300.

Therefore, all content information of the programs being broadcast at the time reserved by the user is stored in the hard disk drive 310 of the recorder 300. Then, the user selects content information that the user wants to print on the acquired content information list window W40 displayed in step S314. With such a structure, the user does not have to identify the broadcaster at the time of making the content information acquisition reservation and thus the user can acquire the content information using the recorder 300 with simpler operations.

Moreover, step S316 may be modified such that the content information designated by the user can be displayed on the display screen 252. In this case, the recorder 300 displays the content information selected by the user on the acquired content information list window W40 on the display screen 252. Moreover, the user may input a print command into the recorder 300 after checking the displayed contents.

Although exemplary embodiments of the invention have been described with reference to the accompanying drawings, the invention is not limited to such embodiments. For example, although the invention has been described for the case where the printer 150 is used as the content information acquisition request unit in the first and second embodiments, and the recorder 300 is used as the content information acquisition request unit in the third embodiment, the content information acquisition request unit is not limited to the printer 150 or the recorder 300. For example, the content information acquisition request unit may be configured by a desktop PC, a laptop PC, a cellular phone, and the like that can access the relay server computer 120.

Moreover, the content information database that the relay server computer 120 or the broadcaster server computer 110 constructs may have an arbitrary structure, and the configuration of the database is only an example.

In addition, a program for executing the processes described in the embodiments may be recorded on a computer-readable recording medium such as a flexible disc, a CD-ROM (compact disc-read only memory), a ROM, or a memory card and distributed in the form of the recording medium. In this case, the above-described embodiments can be realized when the program recorded on the recording medium is read into and executed by the broadcaster server computer 110, the relay server computer 120, the printer 150, and the recorder 300.

Moreover, the broadcaster server computer 110, the relay server computer 120, the printer 150, and the recorder 300 usually have installed therein other programs such as an operating system or other application programs. In this case, in order to utilize other programs provided in the broadcaster server computer 110, the relay server computer 120, the printer 150, and the recorder 300, among the programs installed in the broadcaster server computer 110, the relay server computer 120, the printer 150, and the recorder 300, a program containing therein instructions for invoking a program capable of realizing the processes equivalent to those of the above-described embodiments may be recorded on the recording medium.

Furthermore, such a program may be distributed, not in the form of the recording medium, but in the form of a carrier wave via a network. When the program distributed in the form of the carrier wave over the network is received and executed by the broadcaster server computer 110, the relay server computer 120, the printer 150, and the recorder 300, the above-described embodiments can be realized.

In addition, when the program is recorded on the recording medium or transmitted as the carrier wave over the network, the program is sometimes encrypted or compressed. In this case, the broadcaster server computer 110, the relay server computer 120, the printer 150, and the recorder 300 which have read the program from the recording medium or the carrier wave need to decrypt or expand the program prior to executing the program.

In addition, although the embodiments have been described for the case where the respective processes are realized by software, the respective processes may be realized by hardware such as an ASIC (application specific IC). Moreover, the respective processes may be realized by collaboration of software and hardware.

What is claimed is:

1. A relay server computer that is connected to a broadcaster server computer of a broadcaster and a content information acquisition request unit of a user via a network, comprising:
a content information database constructing unit that acquires content information from the broadcaster server computer to construct a content information database;
a content information acquisition request receiving unit that receives a content information acquisition request from the content information acquisition request unit;
a content information acquisition unit that searches through the content information database to acquire content information corresponding to the content information acquisition request when the content information acquisition request receiving unit has received the content information acquisition request; and
a content information transmitting unit that transmits the content information acquired by the content information acquisition unit to the content information acquisition request unit.

2. The relay server computer according to claim 1, wherein:
the content information acquisition request includes a designation of a broadcaster that is requested to transmit the content information; and,
the content information acquisition unit searches through the content information database to acquire content information of the broadcaster included in the content information acquisition request.

3. The relay server computer according to claim 2, further comprising a reception date identification unit that identifies the date at which the content information acquisition request receiving unit receives the content information acquisition request,
wherein the content information acquisition unit acquires the content information that corresponds to the broadcaster included in the content information acquisition request and the date identified by the reception date identification unit from the content information database.

4. The relay server computer according to claim 1, further comprising:
a reception date identification unit that identifies the date at which the content information acquisition request receiving unit receives the content information acquisition request;
a content information view list transmitting unit that identifies content information of all broadcasters corresponding to the date identified by the reception date identification unit, generates a content information view list thereof, and transmits the content information view list to the content information acquisition request unit; and
a transmission content designation receiving unit that receives a transmission content designation, which is information for identifying content information designated based on the content information view list,
wherein the content information acquisition unit searches through the content information database to acquire content information corresponding to the transmission content designation when the transmission content designation receiving unit has received the transmission content designation.

5. The relay server computer according to claim 4, wherein:
the content information database stores therein additional information data accompanying the content information so as to correspond to the content information; and,
the content information view list transmitting unit searches through the content information database to acquire the additional information data with respect to the content information of all broadcasters corresponding to the date identified by the reception date identification unit, and transmits the additional information data to the content information acquisition request unit with the additional information data included in the content information view list.

6. The relay server computer according to claim 1, wherein the content information database constructed by the content information database constructing unit stores therein the content information, the broadcasters, and the broadcast time of the broadcasters in a correlated manner.

7. A printer that is connected via a network to a relay server computer having a content information database constructed by content information acquired from a broadcaster server computer, comprising:
a print request receiving unit that receives a content information print request from a user;
a content information print request transmitting unit that transmits a content information print request to the relay server computer when the print request receiving unit has received the content information print request;
a print data receiving unit that receives print data in response to the content information print request from the relay server computer; and
a print execution unit that executes printing based on the print data received by the print data receiving unit.

8. A content information delivery system having a relay server computer that delivers content information acquired from a broadcaster server computer of a broadcaster to a content information acquisition request unit of a user via a network, wherein:
the relay server computer comprises a content information database constructing unit that acquires content information from the broadcaster server computer to construct a content information database;
the content information acquisition request unit comprises:
a content information acquisition request receiving unit that receives a content information acquisition request from a user; and
a content information acquisition request transmitting unit that transmits a content information acquisition request to the relay server computer when the content information acquisition request receiving unit has received the content information acquisition request;
the relay server computer further comprises:
a content information acquisition request receiving unit that receives the content information acquisition request from the content information acquisition request unit;
a content information acquisition unit that searches through the content information database to acquire content information corresponding to the content information acquisition request when the content information acquisition request receiving unit has received the content information acquisition request; and
a content information transmitting unit that transmits the content information acquired by the content information acquisition unit to the content information acquisition request unit; and,
the content information acquisition request unit further comprises a content information receiving unit that receives the content information from the relay server computer.

9. The content information delivery system according to claim 8, wherein the content information acquisition request unit further comprises a print execution unit that executes printing based on the content information received by the content information receiving unit.

10. The content information delivery system according to claim 8, wherein the content information acquisition request unit further comprises a content information storage unit that stores the content information received by the content information receiving unit.

11. A recorder that is connected via a network to a relay server computer having a content information database constructed by content information acquired from a broadcaster server computer, comprising:
a content information acquisition request receiving unit that receives a content information acquisition request from a user;
a content information acquisition request transmitting unit that transmits the content information acquisition request to the relay server computer when the content information acquisition request receiving unit has received the content information acquisition request;
a content information receiving unit that receives content information in response to the content information acquisition request from the relay server computer; and
a content information storage unit that stores the content information received by the content information receiving unit.
